(19) United States
(12) Patent Application Publication
(10) Pub. No.: US 2019/0195257 A1
(43) Pub. Date: Jun. 27, 2019

(54) Pipe Connector Structure

(71) Applicant: Chi-Feng Yu, Taipei City (TW)

(72) Inventor: Chi-Feng Yu, Taipei City (TW)

(21) Appl. No.: 15/849,741

(22) Filed: Dec. 21, 2017

(51) Int. Cl. F16B 12/40

(52) U.S. Cl. CPC F16B 12/40

(57) ABSTRACT

A pipe connector structure contains: a body and multiple fitting elements. The body includes multiple first coupling portions. The multiple fitting elements includes multiple second coupling portions arranged on first ends thereof respectively, and the multiple fitting elements includes multiple third coupling portions formed on second ends thereof individually. The multiple second coupling portions of the multiple fitting elements are removably connected with any one of the multiple first coupling portions of the body, and the multiple third coupling portions of the multiple fitting elements are configured to accommodate multiple hollow pipes individually.

### BACKGROUND OF THE INVENTION

### Field of the Invention

The present invention relates to a connector for pipes, and more particularly to a pipe connector structure which removes and connects multiple fitting elements based on using requirements, and the multiple fitting elements have different sizes so as to mate with hollow pipes of different quantities and diameters, to form shelves, furniture or kitchen cabinets of various specifications and shapes, to reduce fabrication cost, and to obtain easy connection.

### Description of the Prior Art

Shelves, kitchen cabinets, or furniture are connected by customers themselves in daily life by connecting various pipes with connectors. Each of the connectors has at least two connection legs (such as three or more than three connection legs) integrally extending from a peripheral side of a body of the connector so as to connect pipes of various quantities to produce shelves, kitchen cabinets, or furniture.

However, as desiring to change designs or appearances of the shelves, kitchen cabinets, or furniture, different connectors having connection legs of different quantities are used. However, the different connectors are manufactured respectively and cause various mold costs, thus having high fabrication cost.

The present invention has arisen to mitigate and/or obviate the afore-described disadvantages.

### SUMMARY OF THE INVENTION

The primary objective of the present invention is to provide a pipe connector structure which removes and connects multiple fitting elements based on using requirements, and multiple fitting elements have different sizes so as to mate with hollow pipes of different quantities and diameters, to form shelves, furniture or kitchen cabinets of various specifications and shapes, and to reduce fabrication cost.

To obtain above-mentioned objectives, a pipe connector structure provided by the present invention contains: a body and multiple fitting elements.

The body includes multiple first coupling portions. The multiple fitting elements includes multiple second coupling portions arranged on first ends thereof respectively, and the multiple fitting elements includes multiple third coupling portions formed on second ends thereof individually. The multiple second coupling portions of the multiple fitting elements are removably connected with any one of the multiple first coupling portions of the body, and the multiple third coupling portions of the multiple fitting elements are configured to accommodate multiple hollow pipes individually.

The multiple first coupling portions of the body have multiple arcuate grooves respectively, sizes of arcs of the multiple arcuate grooves are more than ½ of circumferences of the multiple arcuate grooves, and widths of multiple openings of the multiple arcuate grooves are less than diameters of circles of the multiple arcuate grooves respectively. The multiple second coupling portions of the multiple fitting elements have multiple arcuate ribs corresponding to the multiple arcuate grooves respectively, and multiple second small-diameter segments of the multiple arcuate ribs slide from multiple first large-diameter segments of the multiple arcuate grooves so as to retain with multiple first small-diameter segments of the second ends of the multiple arcuate grooves.

Preferably, first ends of the multiple arcuate grooves respectively have circular diameters of the multiple first large-diameter segments are more than the circular diameters of the multiple first small-diameter segments of the second ends of the multiple arcuate grooves, the multiple arcuate ribs are in a conical strap shape and have multiple second large-diameter segments and the multiple second small-diameter segments, the multiple second small-diameter segments of the multiple arcuate ribs slide from the multiple first large-diameter segments of the multiple arcuate grooves so as to retain with the multiple first small-diameter segments of the second ends of the multiple arcuate grooves, wherein the multiple second large-diameter segments retain in the multiple first large-diameter segments of the multiple arcuate grooves, and the multiple fitting elements force the multiple arcuate ribs to remove from the multiple first large-diameter segments of the multiple arcuate grooves.

Preferably, the body includes multiple planes, the multiple first coupling portions of the body correspond to the multiple planes individually, and the multiple first coupling portions of the body have the multiple arcuate grooves defined thereon respectively.

Preferably, the body includes the multiple planes on which multiple first coupling portion are arranged, and the body includes multiple grooves denting inward from sides of the first coupling portion respectively.

Preferably, the multiple first coupling portions have different sizes respectively, the multiple arcuate grooves of the multiple first coupling portions have different sizes individually, wherein sizes of the multiple second coupling portions of the multiple fitting elements are different from those of the multiple third coupling portions of the multiple fitting elements individually, the multiple arcuate ribs of the multiple second coupling portions have different sizes corresponding to the multiple arcuate grooves individually, the multiple arcuate ribs slidably retain with the multiple arcuate grooves respectively, wherein the multiple third coupling portions of different sizes are configured to accommodate the multiple hollow pipes respectively.

Preferably, the multiple third coupling portions of the multiple fitting elements have multiple first sections, second sections, and third sections of different circular diameters from distal ends of the multiple third coupling portions to the multiple second coupling portions respectively, wherein the multiple first sections are less than the multiple second sections and the multiple third sections, and the multiple third coupling portions have multiple locking rings arranged on outer walls thereof individually, wherein circular diameters of the multiple third sections are largest so as to correspond to external diameters of the multiple hollow pipes, and the multiple second sections correspond to internal diameters of the multiple hollow pipes respectively.

Preferably, the multiple third coupling portions have the multiple locking rings arranged on outer walls thereof individually, and the multiple locking rings are reversely conical and outer diameters of the multiple locking rings increase gradually from the multiple first sections to the multiple second sections.

### BRIEF DESCRIPTION OF THE DRAWINGS

FIG. 1 is a perspective view showing the assembly of a pipe connector structure according to a first embodiment of the present invention.

FIG. 2 is a perspective view showing the exploded components of the pipe connector structure according to the first embodiment of the present invention.

FIG. 3 is a cross sectional view showing the exploded components of a part of the pipe connector structure according to the first embodiment of the present invention.

FIG. 4 is a cross sectional view showing the assembly of the pipe connector structure according to the first embodiment of the present invention.

FIG. 5 is another cross sectional view showing the assembly of the pipe connector structure according to the first embodiment of the present invention.

FIG. 6 is a perspective view showing the operation of the pipe connector structure according to the first embodiment of the present invention.

FIG. 7 is a side plan view showing the application of the pipe connector structure according to the first embodiment of the present invention.

FIG. 8 is a perspective view showing the assembly of a pipe connector structure according to a second embodiment of the present invention.

FIG. 9 is another perspective view showing the assembly of the pipe connector structure according to the second embodiment of the present invention.

FIG. 10 is a perspective view showing the exploded components of the pipe connector structure according to the second embodiment of the present invention.

FIG. 11 is a side plan view showing the assembly of the pipe connector structure according to the second embodiment of the present invention.

FIG. 12 is another side plan view showing the assembly of the pipe connector structure according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

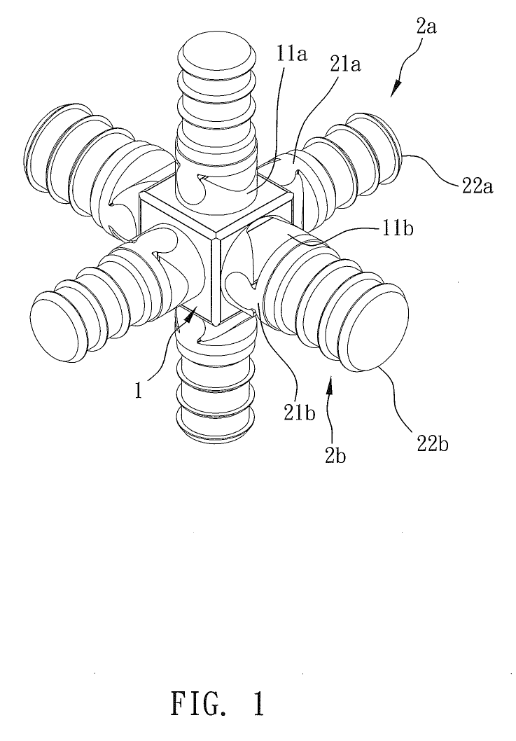

With reference to FIGS. 1-5, a pipe connector structure in accordance with a first embodiment of the present invention is applied to connect multiple hollow pipes and comprises: a body 1 including multiple first coupling portions 11 (11a, 11b); multiple fitting elements 2 (2a, 2b) including multiple second coupling portions 21 (21a, 21b) arranged on first ends of the multiple fitting elements 2 (2a, 2b) respectively, and the multiple fitting elements 2 (2a, 2b) including multiple third coupling portions 22 (22a, 22b) formed on second ends of the fitting elements 2 (2a, 2b) individually, wherein the multiple second coupling portions 21 (21a, 21b) of the multiple fitting elements 2 (2a, 2b) are removably connected with any one of the multiple first coupling portions 11 (11a, 11b) of the body 1, and the multiple third coupling portions 22 (22a, 22b) of the multiple fitting elements 2 (2a, 2b) are configured to accommodate multiple hollow pipes 9 (9a, 9b) individually.

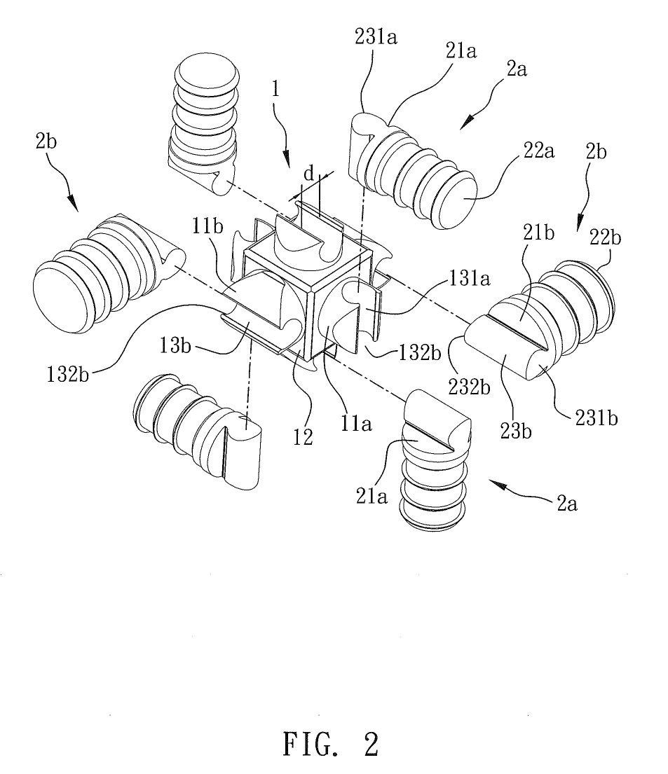

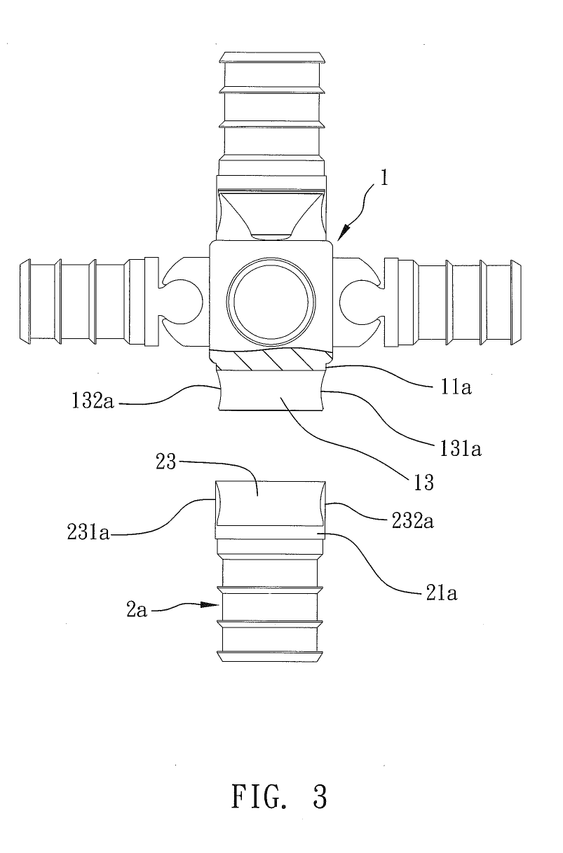

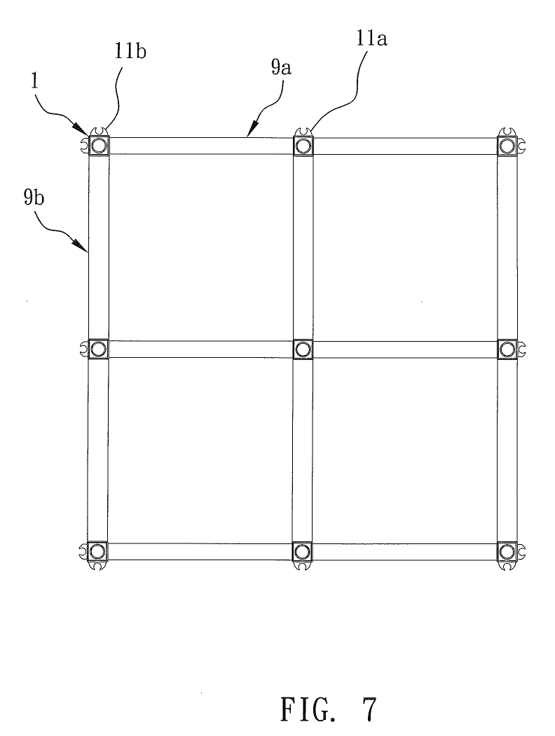

Referring to FIG. 2, the body 1 includes multiple planes 12, the multiple first coupling portions 11 (11a, 11b) of the body 1 correspond to the multiple planes 12 individually, and the multiple first coupling portions 11a, 11b have different sizes respectively, the multiple first coupling portions 11 (11a, 11b) of the body 1 have multiple arcuate grooves 13 (13a, 13b) defined thereon respectively, wherein the multiple arcuate grooves 13 (13a, 13b) have different sizes individually. Sizes of the multiple fitting elements 2 (2a, 2b) are different, wherein the sizes of the multiple second coupling portions 21 (21a, 21b) of the multiple fitting elements 2 (2a, 2b) are different from those of the multiple third coupling portions 22 (22a, 22b) of the multiple fitting elements 2 (2a, 2b) individually. The multiple second coupling portions 21 (21a, 21b) of the multiple fitting elements 2 (2a, 2b) have multiple arcuate ribs 23 (23a, 23b) corresponding to the multiple arcuate grooves 13 (13a, 13b) respectively, the multiple arcuate ribs 23 (23a, 23b) have different sizes corresponding to the multiple arcuate grooves 13a, 13b individually, wherein the multiple third coupling portions 22 (22a, 22b) of different sizes are configured to accommodate the multiple hollow pipes 9 (9a, 9b) respectively. Sizes of arcs of the multiple arcuate grooves 13 (13a, 13b) are more than ½ of circumferences of the multiple arcuate grooves 13 (13a, 13b) (it is preferable that the sizes of the arcs of the multiple arcuate grooves 13 (13a, 13b) are more than ⅔ of the circumferences of the multiple arcuate grooves 13 (13a, 13b)), and widths of multiple openings d of the multiple arcuate grooves 13 (13a, 13b) are less than diameters of circles of the multiple arcuate grooves 13 respectively, wherein first ends of the multiple arcuate grooves 13 (13a, 13b) respectively have circular diameters of the multiple first large-diameter segments 131 (131a, 131b) are more than the circular diameters of the multiple first small-diameter segments 132 (132a, 132b) of the second ends of the multiple arcuate grooves 13 (13a, 13b). The multiple arcuate ribs 23 (23a, 23b) are in a conical strap shape and have multiple second large-diameter segments 231 (231a, 231b) and multiple second small-diameter segments 232 (232a, 232b) (taking the multiple fitting elements 2a and the multiple first coupling portions 11a for example, as shown in FIG. 3), in assembly, the multiple second small-diameter segments 232 (232a, 232b) of the multiple arcuate ribs 23 (23a, 23b) slide from the multiple first large-diameter segments 131 (131a, 131b) of the multiple arcuate grooves 13 (13a, 13b) so as to retain with the multiple first small-diameter segments 132 (132a, 132b) of the second ends of the multiple arcuate grooves 13 (13a, 13b), wherein the multiple second large-diameter segments 231 (231a, 231b) retain in the multiple first large-diameter segments 131 (131a, 131b) of the multiple arcuate grooves 13 (13a, 13b), hence more than ½ of circumferences of the multiple arcuate grooves 13 (13a, 13b) surround the multiple arcuate ribs 23 (23a, 23b) so that the multiple arcuate ribs 23 (23a, 23b) do not remove from the multiple openings d of the multiple arcuate grooves 13 (13a, 13b), and the multiple fitting elements 2 (2a, 2b) force the multiple arcuate ribs 23 (23a, 23b) to remove from the multiple first large-diameter segments 131 (131a, 131b) of the multiple arcuate grooves 13 (13a, 13b) by using the multiple arcuate grooves 13 (13a, 13b) and the multiple arcuate ribs 23 (23a, 23b) respectively. Thereby, the multiple fitting elements 2 (2a, 2b) are connected with and removed from the body 1 by engaging/disengaging the multiple arcuate ribs 23 (23a, 23b) in/from the multiple arcuate grooves 13 (13a, 13b) respectively in any quantities and configurations (for example, one body 1 is connected with five fitting elements 2 (2a, 2b)) so that the pipe connector structure connects with the multiple hollow pipes 9 (9a, 9b) so as to form shelves, furniture or kitchen cabinets (as shown in FIG. 7) of various specifications and shapes, thus overcoming shortcoming of conventional connector, i.e., the conventional connector cannot be connected with the multiple hollow pipes 9 (9a, 9b) of different diameters so as to form the shelves, furniture or kitchen cabinets of various shapes and appearances. In other words, the conventional connectors of different sizes have to match with connection legs of different quantities individually, thus having high fabrication cost. The multiple third coupling portions 22 (22a, 22b) of the multiple fitting elements 2 (2a, 2b) have multiple first sections 221 (221a, 221b), second sections 222 (222a, 222b), and third sections 223 (223a, 223b) of different circular diameters from distal ends of the multiple third coupling portions 22 (22a, 22b) to the multiple second coupling portions 21 (21a, 21b) respectively, wherein the circular diameter of the multiple first sections 221 (221a, 221b) are smallest, and the multiple first sections 221 (221a, 221b) have multiple locking rings 24 (24a, 24b) arranged on outer walls thereof individually, wherein circular diameters of the multiple third sections 223 (223a, 223b) are largest so as to correspond to multiple external fences 91 of the multiple hollow pipes 9 (9a, 9b), and the multiple second sections 222 (222a, 222b) correspond to the multiple internal fences 92 of the multiple hollow pipes 9 (9a, 9b) respectively. The multiple locking rings 24 (24a, 24b) are reversely conical and outer diameters of the multiple locking rings 24 (24a, 24b) increase gradually from the multiple first sections 221 (221a, 221b) to the multiple second sections 222 (222a, 222b) so that the multiple hollow pipes 9 (9a, 9b) are inserted into the multiple third coupling portions 22 (22a, 22b) individually, hence the multiple locking rings 24 (24a, 24b) abut against the multiple internal fences 92 of the multiple hollow pipes 9 (9a, 9b) respectively.

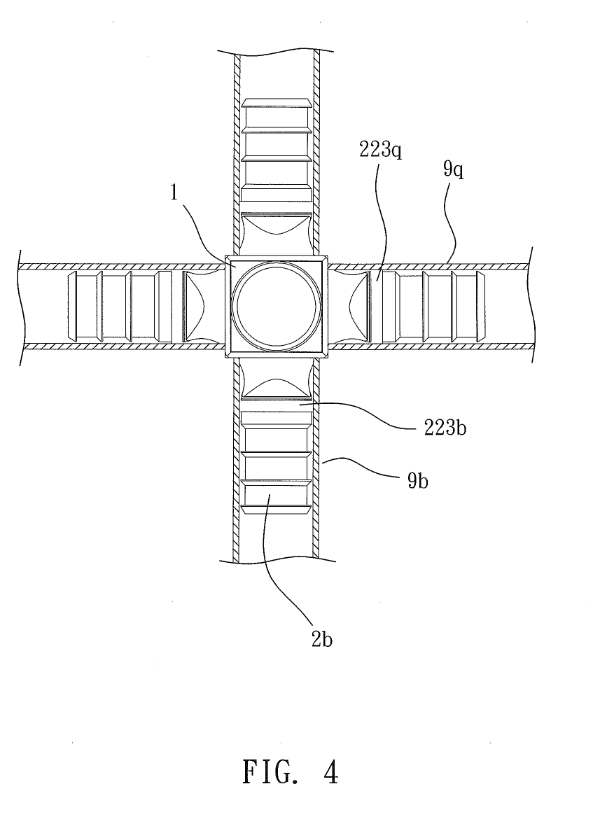

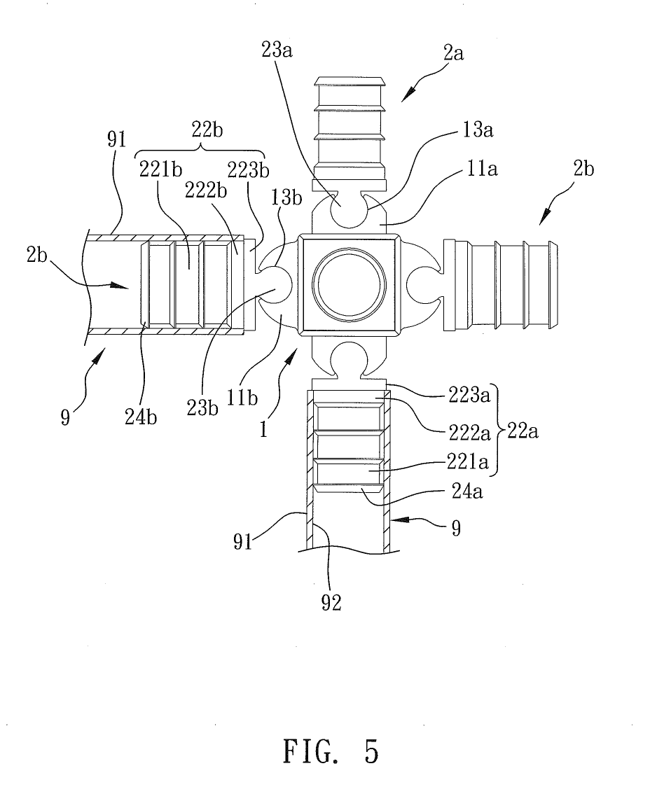

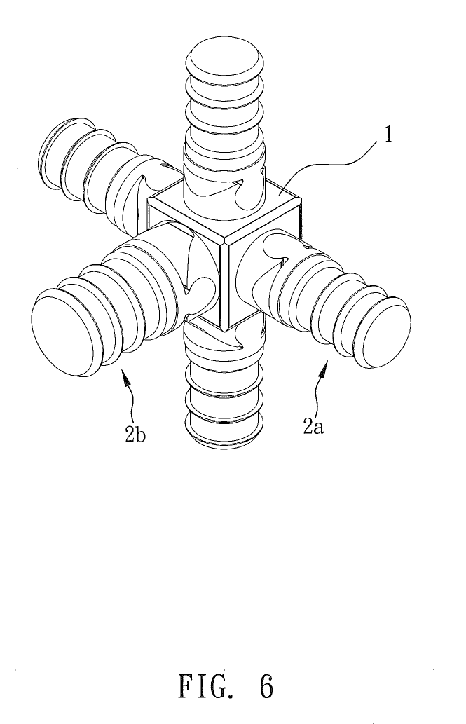

The multiple hollow pipes 9 (9a, 9b) are connected with the multiple third coupling portions 22 (22a, 22b) in two connecting manners. For example, the multiple third sections 223 (223a, 223b) contact with the multiple internal fences 92 of the multiple hollow pipes 9 (9a, 9b) respectively (as shown in FIG. 4). Alternatively, the multiple third sections 223 (223a, 223b) abut against the multiple hollow pipes 9 (9a, 9b) individually (as illustrated in FIG. 5).

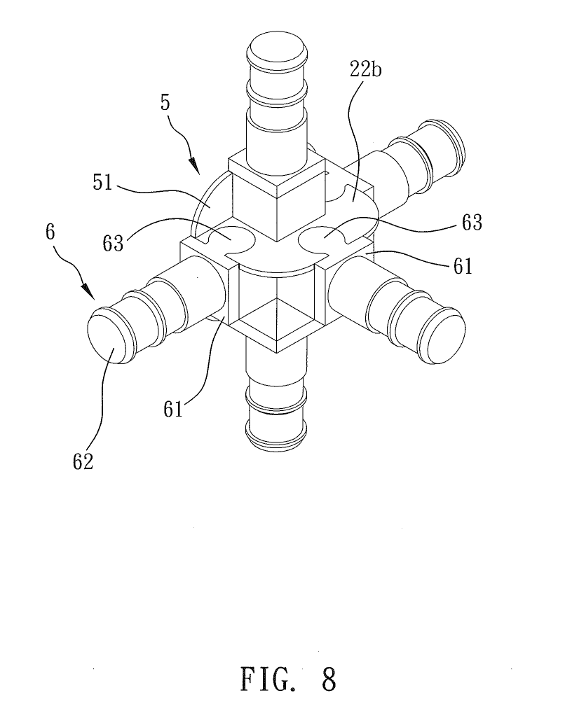

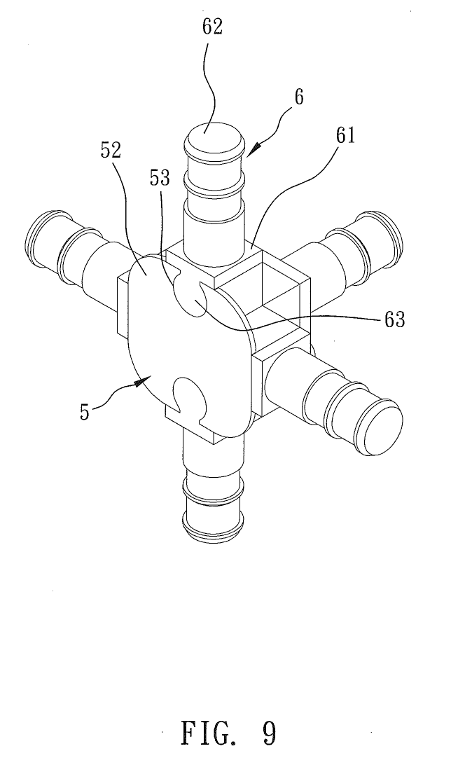

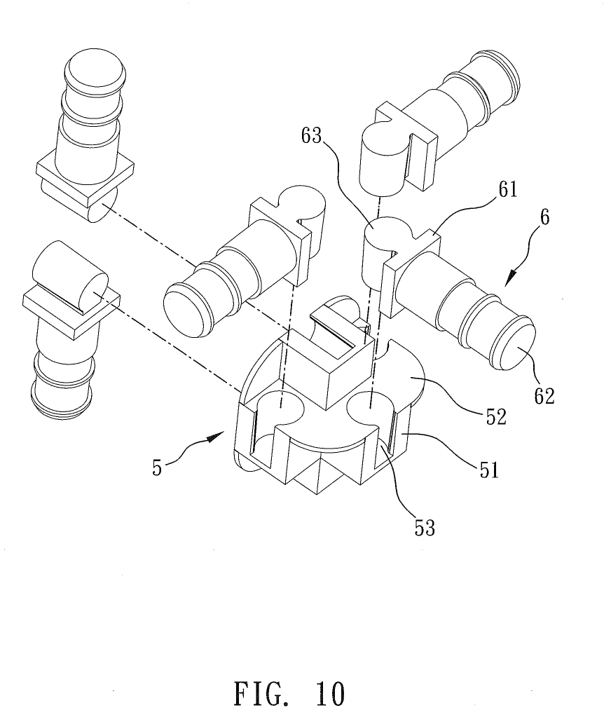

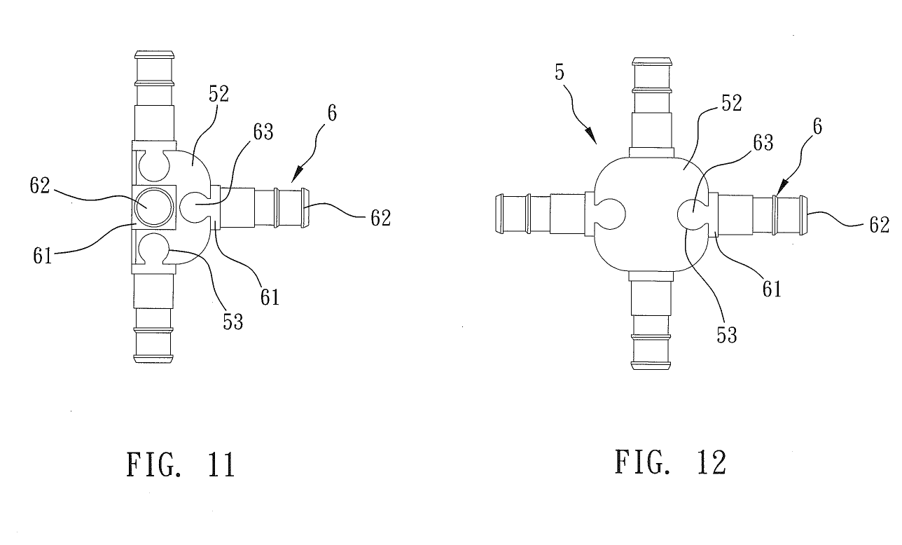

Referring to FIGS. 8-12, a difference of a pipe connector structure of a second embodiment from that of the first embodiment comprises: a body 5 including multiple planes 52 on which multiple first coupling portion 51 are arranged, and the body 5 including multiple grooves 53 denting inward from sides of the first coupling portion 51 respectively, wherein one ends of the multiple grooves 53 are closed. The pipe connector structure further comprises the multiple fitting elements 6 including multiple second coupling portions 61 which are square and are configured to contact with the multiple grooves 53 individually. Sizes of the multiple grooves 53, the multiple second coupling portions 61, multiple third coupling portions 62, and multiple arcuate ribs 63 of the multiple fitting elements 6 are different so as to mate with the multiple hollow pipes 9 (9a, 9b) of different sizes (not shown), hence the multiple fitting elements are removed and connected so as to connect with the multiple hollow pipes of different quantities and sizes, thus connecting shelves, furniture or kitchen cabinets of various specifications and shapes.

The body 1, 5 have the multiple first coupling portions 11 (11a, 11b), 51 respectively, and the multiple first coupling portions 11 (11a, 11b), 51 have the multiple arcuate grooves 13 (13a, 13b), 53 individually, wherein the multiple arcuate grooves 13 (13a, 13b), 53 have different sizes so that multiple fitting elements 2 (2a, 2b), 6 of different sizes selectively connect with the multiple first coupling portions 11 (11a, 11b), 51 of the body 1, 5, and remove from the multiple arcuate grooves 13 (13a, 13b), 53 respectively, hence quantities of the multiple fitting elements 2 (2a, 2b), 6 of the body 1, 5 are changeable based on using requirements so as to form the pipe connector structure having the multiple fitting elements 2 (2a, 2b), 6 of different quantities, thus avoiding fabrication cost of mold of the conventional connector having the connection legs of different quantities. The multiple fitting elements 2 (2a, 2b), 6 have the multiple third coupling portions 22 (22a, 22b), 62 of different sizes and connect with the multiple hollow pipes 9 (9a, 9b) of different diameters so as to form shelves, furniture or kitchen cabinets of various specifications and shapes and to reduce fabrication cost.

While various embodiments in accordance with the present invention have been shown and described, it is clear to those skilled in the art that further embodiments may be made without departing from the scope of the present invention.

What is claimed is:

1. A pipe connector structure comprising:
a body including multiple first coupling portions;
multiple fitting elements including multiple second coupling portions arranged on first ends of the multiple fitting elements respectively, and the multiple fitting elements including multiple third coupling portions formed on second ends of the fitting elements individually, wherein the multiple second coupling portions of the multiple fitting elements are removably connected with any one of the multiple first coupling portions of the body, and the multiple third coupling portions of the multiple fitting elements are configured to accommodate multiple hollow pipes individually.

2. The pipe connector structure as claimed in claim 1, wherein the multiple first coupling portions of the body have multiple arcuate grooves respectively, sizes of arcs of the multiple arcuate grooves are more than ½ of circumferences of the multiple arcuate grooves, and widths of multiple openings of the multiple arcuate grooves are less than diameters of circles of the multiple arcuate grooves respectively, the multiple second coupling portions of the multiple fitting elements have multiple arcuate ribs corresponding to the multiple arcuate grooves respectively, and multiple second small-diameter segments of the multiple arcuate ribs slide from multiple first large-diameter segments of the multiple arcuate grooves so as to retain with multiple first small-diameter segments of the second ends of the multiple arcuate grooves.

3. The pipe connector structure as claimed in claim 2, wherein first ends of the multiple arcuate grooves respectively have circular diameters of the multiple first large-diameter segments are more than the circular diameters of the multiple first small-diameter segments of the second ends of the multiple arcuate grooves, the multiple arcuate ribs are in a conical strap shape and have multiple second large-diameter segments and the multiple second small-diameter segments, the multiple second small-diameter segments of the multiple arcuate ribs slide from the multiple first large-diameter segments of the multiple arcuate grooves so as to retain with the multiple first small-diameter segments of the second ends of the multiple arcuate grooves, wherein the multiple second large-diameter segments retain in the multiple first large-diameter segments of the multiple arcuate grooves, and the multiple fitting elements force the multiple arcuate ribs to remove from the multiple first large-diameter segments of the multiple arcuate grooves.

4. The pipe connector structure as claimed in claim 3, wherein the body includes multiple planes, the multiple first coupling portions of the body correspond to the multiple planes individually, and the multiple first coupling portions of the body have the multiple arcuate grooves defined thereon respectively.

5. The pipe connector structure as claimed in claim 3, wherein the body includes multiple planes on which the multiple first coupling portion are arranged, and the body includes multiple grooves denting inward from sides of the first coupling portion respectively.

6. The pipe connector structure as claimed in claim 4, wherein the multiple first coupling portions have different sizes respectively, the multiple arcuate grooves of the multiple first coupling portions have different sizes individually, wherein sizes of the multiple second coupling portions of the multiple fitting elements are different from those of the multiple third coupling portions of the multiple fitting elements individually, the multiple arcuate ribs of the multiple second coupling portions have different sizes corresponding to the multiple arcuate grooves individually, the multiple arcuate ribs slidably retain with the multiple arcuate grooves respectively, wherein the multiple third coupling portions of different sizes are configured to accommodate the multiple hollow pipes respectively.

7. The pipe connector structure as claimed in claim 5, wherein the multiple first coupling portions have different sizes respectively, the multiple arcuate grooves of the multiple first coupling portions have different sizes individually, wherein sizes of the multiple second coupling portions of the multiple fitting elements are different from those of the multiple third coupling portions of the multiple fitting elements individually, the multiple arcuate ribs of the multiple second coupling portions have different sizes corresponding to the multiple arcuate grooves individually, the multiple arcuate ribs slidably retain with the multiple arcuate grooves respectively, wherein the multiple third coupling portions of different sizes are configured to accommodate the multiple hollow pipes respectively.

8. The pipe connector structure as claimed in claim 6, wherein the multiple third coupling portions of the multiple fitting elements have multiple first sections, second sections, and third sections of different circular diameters from distal ends of the multiple third coupling portions to the multiple second coupling portions respectively, wherein the circular diameter of the multiple first sections are smallest, and the multiple first sections have multiple locking rings arranged on outer walls thereof individually, wherein circular diameters of the multiple third sections are largest so as to correspond to multiple external diameters of the multiple hollow pipes, and the multiple second sections correspond to internal diameters of the multiple hollow pipes respectively.

9. The pipe connector structure as claimed in claim 7, wherein the multiple third coupling portions of the multiple fitting elements have multiple first sections, second sections, and third sections of different circular diameters from distal ends of the multiple third coupling portions to the multiple second coupling portions respectively, wherein the circular diameter of the multiple first sections are smallest, and the multiple first sections have multiple locking rings arranged on outer walls thereof individually, wherein circular diameters of the multiple third sections are largest so as to correspond to multiple external diameters of the multiple hollow pipes, and the multiple second sections correspond to internal diameters of the multiple hollow pipes respectively.

10. The pipe connector structure as claimed in claim 8, wherein the multiple first sections of the multiple third coupling portions have the multiple locking rings arranged on outer walls thereof individually, and the multiple locking rings are reversely conical and outer diameters of the multiple locking rings increase gradually from the multiple first sections to the multiple second sections.

11. The pipe connector structure as claimed in claim 9, wherein the multiple first sections of the multiple third coupling portions have the multiple locking rings arranged on outer walls thereof individually, and the multiple locking rings are reversely conical and outer diameters of the multiple locking rings increase gradually from the multiple first sections to the multiple second sections.
